(19) United States
(12) Patent Application Publication
(10) Pub. No.: US 2008/0060917 A1
(43) Pub. Date: Mar. 13, 2008

(54) Lighting device with a magnetic switch

(76) Inventors: Chen Chia-Li, Zhong-He City (TW); Tseng Jui-Huang, Zhong-He City (TW)

Correspondence Address: TROXELL LAW OFFICE PLLC, 5205 LEESBURG PIKE, SUITE 1404, FALLS CHURCH, VA, 22041, US

(21) Appl. No.: 11/882,624

(22) Filed: Aug. 3, 2007

(30) Foreign Application Priority Data
Sep. 8, 2006 (TW) 095216076

(51) Int. Cl. F21V 23/04

(52) U.S. Cl. 200/60

(57) ABSTRACT

A lighting device with a magnetic switch is disclosed, wherein plural magnetic fields are produced by utilizing a magnetic piece and a magnetic induction element together with a ring structure to form circuits equivalent to functional keys and make a lighting element produce plural induction effects under the control of a magnetic induction element via a circuit board, so that the lighting device can be operated easily.

### BACKGROUND OF THE INVENTION

1. Field of the Invention

The present invention relates to a lighting device with a magnetic switch and, more particularly, to a lighting device with a magnetic switch wherein plural magnetic fields are produced as a result of the relative change of the positions of a magnetic piece and a magnetic induction element to make a lighting element produce plural induction effects under the control of the magnetic induction element via a circuit board.

2. Description of the Prior Art

With respect to multifunctional portable lighting devices such as a flashlight, it is difficult to design the lighting devices where all setting and operations can be controlled by one key because of size, appearance, and waterproofing problems. Even the design of multiple keys are applied, it is necessary to add many extra waterproof structures. Besides, some lighting devices are designed to have multiple keys controlled by pressing the keys at intervals and in sequence for performing different functions. For example, in case of using single key to control all functions (such as off-mode 0-mode 1-mode 2- . . . -off), it is difficult for users to definitely ascertain the instant status and to enter the desired mode directly. Moreover, in case of using a set of keys to control all functions, it is difficult to make the lighting devices waterproof due to the difficulty in designing the structure of the lighting devices.

Therefore, the present invention focuses on providing a lighting device that is easy to be operated and waterproof.

In order to overcome the shortcomings mentioned above to provide a lighting device with a magnetic switch wherein plural magnetic fields are produced as a result of the relative change of the positions of a magnetic piece and a magnetic induction element to make a lighting element produce plural induction effects under the control of the magnetic induction element via a circuit board, inventor had the motive to study and develop the present invention after hard research.

### SUMMARY OF THE INVENTION

An object of the present invention is to provide a lighting device with a magnetic switch, which can be easily operated by using the combination of a magnetic induction element and a magnet together with a ring structure for producing circuits equivalent to the functional keys.

In order to achieve the above object, the present invention provides a lighting device with a magnetic switch comprising: a switching unit provided on a main body of the lighting device; at least a magnetic piece disposed in the switching unit; a circuit board disposed in the main body; at least a magnetic induction element disposed on the circuit board; a lighting element disposed on the circuit board. When the switching element is switched on the main body, a plurality of magnetic fields is produced between the magnetic piece and the magnetic induction element, and the plural magnetic fields make a lighting element produce plural induction effects under the control of the magnetic induction element via the circuit board.

Therefore, plural magnetic fields are produced as a result of the relative change of the positions of a magnetic piece and a magnetic induction element to make a lighting element produce plural induction effects under the control of the magnetic induction element via a circuit board.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 is an exploded perspective view of a preferred embodiment of a lighting device with a magnetic switch of the present invention.

FIG. 2 is a sectional view of the preferred embodiment of the present invention.

FIG. 3 is a perspective view of the preferred embodiment of the present invention.

### DETAILED DESCRIPTION OF THE PREFERRED EMBODIMENTS

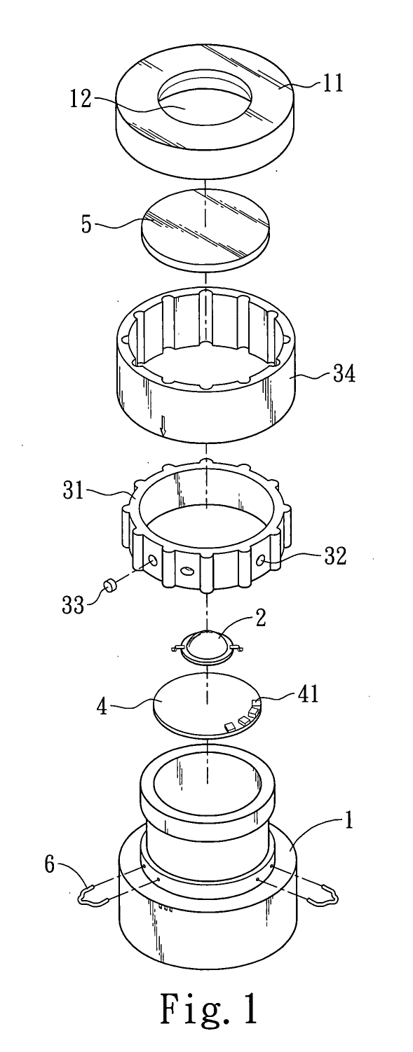

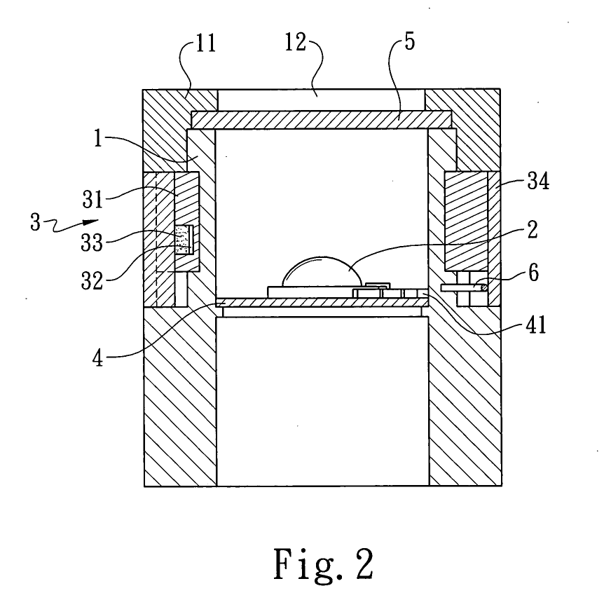

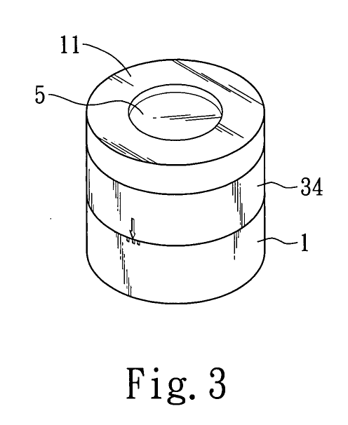

FIGS. 1-3 respectively shows an exploded perspective view, a sectional view, and a perspective view of a preferred embodiment of a lighting device with a magnetic switch according to the present invention. Referring to FIGS. 1-3, the lighting device comprises a main body 1, a switching unit 3, at least a magnetic piece 33, a circuit board 4, at least a magnetic induction element 41, and a lighting element 2.

The switching element 3 can be, but not limited to, a ring structure. The ring structure 3 includes an internal rotating ring 31 and an external rotating ring 34. The outer peripheries of the internal rotating ring 31 are provided with plural protrusions and the inner peripheries of the external rotating ring 34 are provided with plural recesses corresponding to the protrusions. The external rotating ring 34 is connected with the internal rotating ring 31 by the engagement of the protrusions and the recesses. Besides, the ring structure 3 is further provided with a hole 32 for placing a magnet piece 33 (such as, but not limited to, a magnet). Moreover, the ring 3 is provided with a plurality of functional symbols (not shown in the figures).

The main body 1 can be, but not limited to, a round tube. At least an elastic positioning element 6 (such as, but not limited to, an elastic rod) is provided between the main body 1 and the recesses of the external rotating ring 34 for forming plural positioning points when the ring structure 3 is turned. Furthermore, the round tube 1 is provided with an indicative symbol (not shown in the figures). The ring structure 3 is provided on the round tube 1 of the lighting device and is switched by turning the ring structure 3 on the main body 1.

The circuit board 4 can be, but not limited to, a printed circuit board and is disposed in the main body 1. The magnetic induction element 41 is disposed on the circuit board 4 and the lighting element 2 (such as, but not limited to, a light-emitting diode used in a backlight module) is disposed on the circuit board 4. When the ring structure 3 is to be turned and switched on the round tube 1, plural magnetic fields are produced as a result of the relative change of the positions of the magnet 33 and the magnetic induction element 41 to make the lighting element 2 produce plural induction effects under the control of the magnetic induction element 41 via the circuit board 4. In the meanwhile, users can determine a desired induction effect by referring the indicative symbol (not shown in the figures) of the round tube 1 to indicate a certain functional symbol (not shown in the figures) of the ring structure 3.

Moreover, the lighting device with a magnetic switch further includes a covering 11 and a lens 5. The covering 11 is disposed on the round tube 1 and is provided with a hole 12 (such as, but not limited to, a light-emitting hole) and the lens 5 is disposed on the covering 11 and covers the light-emitting hole 12. Besides, the round tube 1 and the ring structure 3 can be made by waterproof material such as, but not limited to, plastic or metal. Therefore, the lighting device is waterproof after it is assembled.

Accordingly, as disclosed in the above description and attached drawings, the present invention can provide a lighting device with a magnetic switch, wherein plural magnetic fields are produced by using the magnetic piece and the magnetic induction element together to form circuits equivalent to the functional keys and make the lighting element produce plural induction effects under the control of the magnetic induction element via the circuit board. It is new, easy to be operated, and can be put into industrial use and meet the need of the market.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A lighting device with a magnetic switch, comprising:
a switching unit provided on a main body of the lighting device;
at least a magnetic piece disposed in the switching unit;
a circuit board disposed in the main body;
at least a magnetic induction element disposed on the circuit board;
a lighting element disposed on the circuit board;
wherein when the switching element is switched on the main body, a plurality of magnetic fields is produced between the magnetic piece and the magnetic induction element, and the plural magnetic fields make the lighting element produce plural induction effects under the control of the magnetic induction element via the circuit board.

2. The lighting device with a magnetic switch as claimed in claim 1, wherein the switching element is to be turned and switched on the main body.

3. The lighting device with a magnetic switch as claimed in claim 1, wherein the switching element is a ring structure.

4. The lighting device with a magnetic switch as claimed in claim 3, wherein the ring structure is made by waterproof material.

5. The lighting device with a magnetic switch as claimed in claim 3, wherein the ring structure is made by plastic or metal.

6. The lighting device with a magnetic switch as claimed in claim 3, wherein the ring structure includes an internal rotating ring and an external rotating ring, the outer peripheries of the internal rotating ring are provided with plural protrusions, and the inner peripheries of the external rotating ring are provided with plural recesses corresponding to the protrusions, so that the external rotating ring is connected with the internal rotating ring by the engagement of the protrusions and the recesses.

7. The lighting device with a magnetic switch as claimed in claim 6, wherein at least an elastic positioning element is provided between the main body and the recesses of the external rotating ring for forming plural positioning points when the ring structure is turned.

8. The lighting device with a magnetic switch as claimed in claim 1, wherein the switching element is provided with a plurality of functional symbols and the main body is provided with an indicative symbol for identifying the induction effects.

9. The lighting device with a magnetic switch as claimed in claim 1, wherein the main body is a round tube.

10. The lighting device with a magnetic switch as claimed in claim 9, wherein the round tube is made by waterproof material.

11. The lighting device with a magnetic switch as claimed in claim 9, wherein the round tube is made by plastic or metal.

12. The lighting device with a magnetic switch as claimed in claim 1, wherein the magnetic piece is a magnet.

13. The lighting device with a magnetic switch as claimed in claim 12, wherein the switching element is provided with at least a hole for placing the magnet.

14. The lighting device with a magnetic switch as claimed in claim 1, wherein the lighting device is a light-emitting diode.

15. The lighting device with a magnetic switch as claimed in claim 1, wherein the circuit board is a printed circuit board.

16. The lighting device with a magnetic switch as claimed in claim 1 further includes a covering and a lens, wherein the covering is disposed on the main body and provided with a hole and the lens is disposed on the covering and covers the hole.
